(19) United States
(12) Patent Application Publication
(10) Pub. No.: US 2017/0116779 A1
(43) Pub. Date: Apr. 27, 2017

(54) VOLUMETRIC REPRESENTATION OF OBJECTS

(71) Applicant: Microsoft Technology Licensing, LLC, Redmond, WA (US)

(72) Inventor: Emmett Lalish, Seattle, WA (US)

(73) Assignee: Microsoft Technology Licensing, LLC, Redmond, WA (US)

(21) Appl. No.: 14/922,587

(22) Filed: Oct. 26, 2015

(51) Int. Cl. G06T 17/20; G06T 15/04; G06T 15/08

(52) U.S. Cl. CPC G06T 17/20; G06T 15/08; G06T 15/04; G06T 2215/16

(57) ABSTRACT

The disclosed subject matter includes techniques for representing properties of three-dimensional objects. A method includes mapping an outer surface of a three-dimensional object as a surface mesh. The method also includes mapping properties of an internal volume of the three-dimensional object into the surface mesh using a volumetric mesh. Additionally, the method includes generating a model of the three-dimensional object based on the surface mesh and the properties from the volumetric mesh. The method further includes building the three-dimensional object based on the model.

### BACKGROUND

There are a number of processes for creating a digital model and producing a three-dimensional (3D) solid object of virtually any shape from that model. These processes may be referred to as three-dimensional printing, rapid prototyping, fused-filament, additive manufacturing, or the like. Three-dimensional manufacturing, such as this, uses data representation techniques to describe the 3D object, i.e., what color and material are used to create the object at each point in 3D space. Advancements in manufacturing have enabled the efficient construction of objects with extremely high complexity. However, current data representation techniques used to support such construction lead to large file sizes, which are not computationally efficient to process. Further, there are no design tools available that can take advantage of the potential complexity of 3D manufacturing. For example, it is very difficult to build detailed internal structures, also referred to herein as microstructures, which provide strength and flexibility in specific directions while saving material and weight. Limitations imposed by such conventional technologies, including but not restricted to those mentioned above, inhibit more complex 3D object fabrication.

### SUMMARY

The following presents a simplified summary of the innovation in order to provide a basic understanding of some aspects described herein. This summary is not an extensive overview of the disclosed subject matter. It is intended to neither identify key elements of the disclosed subject matter nor delineate the scope of the disclosed subject matter. Its sole purpose is to present some concepts of the disclosed subject matter in a simplified form as a prelude to the more detailed description that is presented later.

One implementation provides for a system for volumetric representation of properties of 3D objects. The system can include a processor and a computer-readable memory storage device storing executable instructions that can be executed by the processor to cause the processor to map an outer surface of a three-dimensional object as a surface mesh. The system also includes executable instructions that can be executed by the processor to cause the processor to map properties of an internal volume of the three-dimensional object into the surface mesh using a volumetric mesh. The system also includes executable instructions that can be executed by the processor to cause the processor to generate a model of the three-dimensional object based on the surface mesh and the properties from the volumetric mesh. The system also includes executable instructions that can be executed by the processor to cause the processor to build the three-dimensional object based on the surface boundary and the properties. The system also includes executable instructions that can be executed by the processor to cause the processor to map a surface boundary of the three-dimensional object as polygons that make up a surface mesh. Alternatively, or in addition, the polygons comprise triangles, and the surface mesh comprises a triangle mesh. The example system also includes executable instructions that can be executed by the processor to cause the processor to map an additional surface mesh into internal volumes of the three-dimensional object as voxels in the volumetric mesh. Alternatively, or in addition, the properties comprise a composition of material to be used at a specific point represented by a voxel. Alternatively, or in addition, the composition of material comprises a void of material. The system also includes executable instructions that can be executed by the processor to cause the processor to map an internal model of the three-dimensional object as polyhedrons that make up the volumetric mesh.

Another implementation provides a method for volumetric representation of properties of 3D objects. A method includes mapping an outer surface of a three-dimensional object as a surface mesh. The method also includes mapping properties of an internal volume of the three-dimensional object into the surface mesh using a volumetric mesh. Additionally, the method includes generating a model of the three-dimensional object based on the surface mesh and the properties from the volumetric mesh. The method further includes building the three-dimensional object based on the model. The method also includes mapping an additional surface mesh into internal volumes of the three-dimensional object as voxels in the volumetric mesh. Alternatively, or in addition to, the properties comprise a composition of material to be used at a specific point represented by a voxel. Alternatively, or in addition to, the composition of material comprises a void of material. Alternatively, or in addition to, the method includes mapping an internal model of the three-dimensional object as polyhedrons that make up the volumetric mesh.

Another implementation provides for one or more computer-readable memory storage devices for storing computer readable instructions that, when executed by one or more processing devices, instruct the performance of volumetric representation of properties of 3D objects. The computer-readable instructions can include code to map an outer surface of a three-dimensional object as a surface mesh. The computer-readable instructions may include code to map properties of an internal volume of the three-dimensional object into the surface mesh using a volumetric mesh. The computer-readable instructions may include code to generate a model of the three-dimensional object based on the surface mesh and the properties from the volumetric mesh. The computer-readable instructions may include code to build the three-dimensional object based on the surface boundary and the properties, where the properties comprise manufacturing characteristics. The computer-readable instructions may include code to map an additional surface mesh into internal volumes of the three-dimensional object as voxels in the volumetric mesh. Alternatively, or in addition to, the properties comprise a composition of material to be used at a specific point represented by a voxel, and the composition of material comprises a void of material. The computer-readable instructions may include code to map an internal model of the three-dimensional object as polyhedrons that make up the volumetric mesh.

The following description and the annexed drawings set forth in detail certain illustrative aspects of the disclosed subject matter. These aspects are indicative, however, of a few of the various ways in which the principles of the innovation may be employed and the disclosed subject matter is intended to include all such aspects and their equivalents. Other advantages and novel features of the disclosed subject matter will become apparent from the following detailed description of the innovation when considered in conjunction with the drawings.

### BRIEF DESCRIPTION OF THE DRAWINGS

FIG. 1 is a block diagram of an example fabricator for fabricating a 3D object using a 3D model;

FIG. 2 is a process flow diagram of a method of representing a 3D model for fabrication;

FIG. 3 is a diagram of coincidental triangular and tetrahedral mesh of an example 3D object for manufacture;

FIG. 4 is a diagram of example volumetric meshes for an example 3D object;

FIG. 5 is a diagram of an example volumetric mesh with mirror tiling and the 3D object manufactured from the volumetric mesh; and

FIG. 6 is intended to provide a brief, general description of a computing environment in which the various techniques described herein may be implemented.

### DETAILED DESCRIPTION

Existing data representation techniques include using boundary representations and voxels. A boundary representation is a 3D mesh representation of an object, constructed of multiple two dimensional (2D) surfaces. Each of the surfaces is composed of multiple vertices, where data about the 3D object may be stored. For example, a triangle mesh of an object has 3 vertices at each position (x, y, z) of each triangle in the 3D space represented by the 3D object. At each of these (x, y, z) points, data about the material used to construct the object at that point, and what color the material is, may be stored. Linear gradients of color may also be specified by the definition of different colors at each (x, y, z) vertex of a surface. A linear gradient of color varies continuously with position, providing smooth color transitions.

Using present fabrication techniques, many 3D manufacturers can also create material gradients. Material gradients mix different materials throughout the manufactured 3D object. In this way, different composites, alloys, and the like, transition smoothly from one part of the 3D object to another. However, existing methods of storing the manufacturing data used to generate such objects are limited. Boundary representations scale poorly in the case of representing microstructures. It takes a large number of non-uniform rational Bezier splines (NURBS) to show the surface area and local curvature of 3D objects. This increases dramatically in the volumes typically occupied by microstructures. Similarly, the number of boundaries used to represent such volumes increases dramatically, making boundary representations of microstructures computationally expensive for 3D manufacturing.

Voxels, also referred to herein as volumetric pixels, are values represented in 3D space. A 3D object may alternatively be represented with voxels, and used as described above with respect to the surface mesh. Of boundary representation and voxel representation, voxels are capable of storing the information used for specifying material gradient information. With material gradient information, it is possible for 3D manufacturers to create gradients of material in 3D space similar to how linear gradients of color are created, described above. However, storing material gradient information in voxels is inefficient, as the voxels scale with the mathematical cube (n³) of the printer resolution (n). Additionally, voxels tend to lose data when operated upon.

Embodiments of the claimed subject matter provide a new way to organize and store manufacturing data so that high complexity parts can be represented efficiently on disk. Accordingly, representing manufacturing data in this way also enables efficient operation on the data.

In one embodiment, a volumetric mesh is used to model an interior volume of 3D objects. This volumetric mesh may be used in addition to a surface mesh of the 3D object. For example, the volumetric mesh may be a tetrahedral mesh, and the surface mesh a triangular mesh. In addition to the 3 vertices of the 3D triangle found in a triangle mesh, the tetrahedral mesh provides 4 vertices, potentially at a different resolution than the triangle mesh. Further, the surface mesh and volumetric mesh are disjoint meshes, wherein the surface mesh is a boundary of the object in that the volume occupied by the volumetric mesh outside the surface mesh is ignored, e.g., not manufactured.

In other embodiments of the volumetric mesh, cubes, Voronoi partitions, or other shapes could be used as an alternative to the tetrahedron. In such embodiments, an interpolation method may be specified in order to define the intended value at any intermediate point in the geometry. The interpolation method makes it possible to construct a set of data points for the volume of the polyhedron based on the values stored at the vertices. Regardless of the type of mesh used, data may be associated with the vertices of this mesh. However, with a different interpolation method, the data may be stored differently, for instance, as parameters on the polyhedron. For example, a surface mesh may have two positions for each vertex, with a parameter controlling the interpolation between the two positions. By using these as a microstructure and storing this parameter in each [U,V,W] coordinate, continuous adjustment of the geometry can be achieved, enabling, for instance, variable thickness microstructures. The data may specify material and property information, such as composite material fractions, color, degrees of transparency, degrees of conductivity, voids of material, etc. In this way, it is possible to specify colors, linear gradients, material gradients, and property gradients at the surfaces of the surface mesh, and within the volume of the volumetric mesh. Other data that can be associated with these vertices are (U, V, W) coordinates, which may specify coordinates in of a 3D texture, such as a mesh or a voxel, to be mapped into the represented volume. Such a specification is a direct extension of surface texture mapping common in 3D graphics.

Advantageously, the tetrahedral mesh representation makes it possible to use linear interpolation to specify material and color gradients, within the manufactured object. In this way, specific compositions of materials can be deposited in specific locations within the object. Accordingly, internal strengths of the manufactured 3D object may be constructed in specific directions based on the compositions of the various materials.

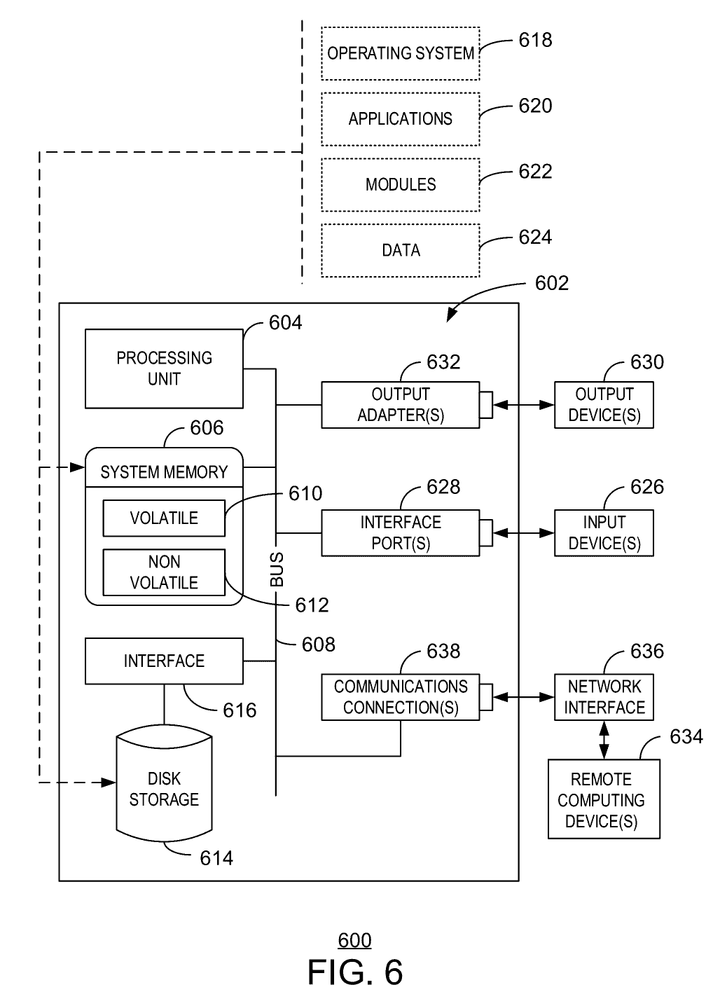

As a preliminary matter, some of the figures describe concepts in the context of one or more structural components, variously referred to as functionality, modules, features, elements, or the like. The various components shown in the figures can be implemented in any manner, such as software, hardware, firmware, or combinations thereof. In some cases, various components shown in the figures may reflect the use of corresponding components in an actual implementation. In other cases, any single component illustrated in the figures may be implemented by a number of actual components. The depiction of any two or more separate components in the figures may reflect different functions performed by a single actual component. FIG. 6, discussed below, provides details regarding one system that may be used to implement the functions shown in the figures.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into multiple component blocks, and certain blocks can be performed in an order that differs from that which is illustrated herein, including a parallel manner of performing the blocks. The blocks shown in the flowcharts can be implemented by software, hardware, firmware, manual processing, or the like. As used herein, hardware may include computer systems, discrete logic components, such as application specific integrated circuits (ASICs), or the like.

As to terminology, the phrase “configured to” encompasses any way that any kind of functionality can be constructed to perform an identified operation. The functionality can be configured to perform an operation using, for instance, software, hardware, firmware, or the like. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the disclosed subject matter may be implemented as a method, apparatus, or article of manufacture using standard programming and engineering techniques to produce software, firmware, hardware, or any combination thereof to control a computing device to implement the disclosed subject matter. The term “article of manufacture,” as used herein is intended to encompass a computer program accessible from any computer-readable storage device or media. Computer-readable storage media include magnetic storage devices, e.g., hard disk, floppy disk, magnetic strips, optical disk, compact disk (CD), digital versatile disk (DVD), smart cards, flash memory devices, among others. Moreover, computer-readable storage media does not include communication media such as transmission media for wireless signals. In contrast, computer-readable media, i.e., not storage media, may include communication media such as transmission media for wireless signals.

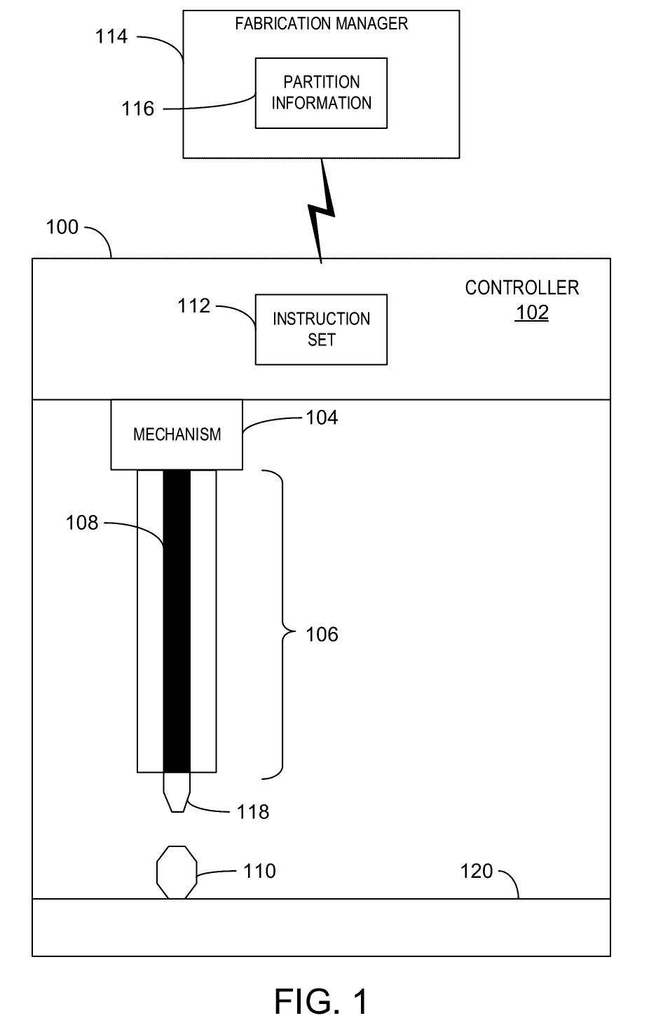

FIG. 1 is a block diagram of an example fabricator 100 for fabricating a 3D object using a 3D model. The fabricator 100 may include a control unit or controller 102 coupled to a first mechanism 104 and configured to execute instructions for the first mechanism 104 and a second mechanism 106. A chamber 108 constructed within the second mechanism 106 allows materials to be prepared, e.g., heated and blended, when fabricating an object 110. For example, the chamber 108 is used for melting and extruding filaments or other compatible materials.

The first mechanism 104 may be referred to as a robotic mechanism, e.g., a gantry robot, including various mechanical or electro-mechanical components. By executing at least some instructions within an instruction set 112, the first mechanism 104 may actuate these components into performing at least some physical movement. The fabrication manager 114 may generate the instruction set 112 by partitioning a 3D model, including an embossed 3D model, into layers and providing specific fabrication instructions for each layer. When actuated, these components may move horizontally, vertically, diagonally, rotationally, and so forth. One example implementation of the first mechanism 104 moves a printing mechanism or tool across an x, y, or z-axis in order to deposit material at a specific position within the object 110 being fabricated.

The second mechanism 106 may be referred to as a printing mechanism that includes one or more printing tool heads. The material may be pushed or pulled into a printing tool head, and the motors may be mounted further away in order to push the material through a thin guide tube into the chamber 108. Although the second mechanism 106 may resemble an extruder configuration, e.g., a single extruder head configuration, it is appreciated that the second mechanism 106 represents any compatible technology, including legacy printing tool heads configured to deposit various types of materials.

The instructions mentioned above, which are stored in an instruction set 112, may be collectively referred to as coordinated instructions because such instructions are executed, in coordination with multiple components. For example, instructions for different stepper motors in an extruder configuration may be coordinated such that an appropriate extrudable material is fed into the chamber 108. Accordingly, an instruction for one stepper motor may be synchronized in time with an instruction for another stepper motor such that both stepper motors can operate in coordination with each other.

The fabrication manager 114 may include hardware and software components operating on various implementations of computing devices, such as a remote computing device and an attached computing device. One example implementation of the fabrication manager 114 processes a 3D model corresponding to an object being fabricated and partitions that information into layers in which each layer includes at least some geometry, which may include geometric elements corresponding to a surface mesh. The present disclosure may use “partition”, “slice”, or another similar term in place of “layer,” and it is appreciated that these terms be defined as interchangeable.

Within partition information 116, the fabrication manager 114 stores a data structure corresponding to the 3D model. Geometry generally refers to a set of geometric elements, such as a 3D polyhedron or other shape, which may represent an amount of extrudable material to be deposited. One example measure represents at least a portion of the geometry—and therefore, the amount of extrudable material—volumetrically. The example measure may define a portion of the geometry using standardized units in which each unit represents a minimal amount, e.g., volume, of colored material at a given time instance, such as by an extrusion width. Each geographic element may include one or more standardized units.

The fabrication manager 114 is configured to generate instructions that, when executed by the controller 102, actuate components of the first mechanism 104, which may result in movements of the second mechanism 106 following a surface geometry, e.g., an exterior shell of the object 110. Optionally, a movable platform, such as a platform 120, functions as a mechanism for printing the object 110. The first mechanism 104 may operate the platform 120 to guide the object 110 and the nozzle 118 to each other. The instruction set 112 may include instructions for automatically calibrating the platform 120 such that through a series of movements in an x, y, and z direction or in rotation across an x-y plane, the 3D object 110 is moved to a correct position for the nozzle 118 to deposit material.

Some example implementations of the fabricator 100 include legacy devices that are retrofitted with at least some of the components described herein, including the controller 102, the fabrication manager 114, and a printing tool head, such as the second mechanism 106. As one option, the fabricator 100 may include an additional microprocessor to manage the set of motors and to receive a signal from an original microprocessor when a command is processed.

To illustrate one example, a verified manifold object, represented in a 3D mesh model, may be partitioned into layers by processing each polygon representing the object, and projecting each polygon through a slicing plane. This projection generates a point and connections to other points in a manner that eventually creates a path. From this point, the path is reduced to units, e.g., volumetric measures of geometric elements, representing addressable units for a specific hardware characteristic of a corresponding fabricator. The units may not be the same size, axis aligned, and the same size in each dimension. One example implementation may utilize non-cubic units of different sizes along an x, y, or z axis, which enables different effective resolutions per dimension. According to an example implementation, the partition information 116 may include voxelized data such that each addressable (voxel) unit includes a variety of information, such as color, texture, and lighting values, for geometry within that addressable voxel unit.

An example fabricator 100 includes an arrangement of motors and a tool head having a mixing chamber and a nozzle. The tool head also may include a heating element for melting extrudable material to a prescribed temperature. When fabricating the 3D object, the fabrication manager 114 determines an approximate amount of extrudable material capable of being deposited at a given (x, y, z) location. The fabrication manager 114 uses the determined amount to define addressable units on the object's shell. Each unit represents a specific geometric element or a portion of the 3D object. The addressable units may be represented herein as voxelized data, e.g., voxelized data structure. In an example implementation, the fabrication manager 114 determines volume in voxel units, e.g., volumetric pixels. The fabricator's 3D space is factored by a minimum volume of extrudable material. Other information may include implicit values, such as, distance to an object surface mesh, probabilities indicating whether a voxel unit of the object occupies the volume represented. This technique may be applied to the object's entire volume, including the outer shell.

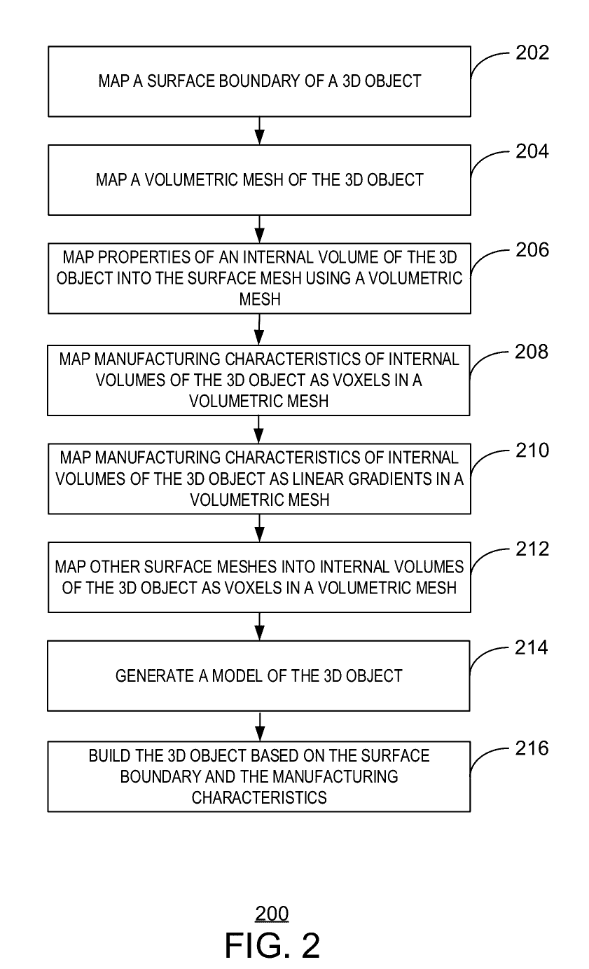

FIG. 2 is a process flow diagram of a method 200 of representing a 3D model for fabrication. One or more components of hardware or software of the operating environment 100, may be configured to perform the method 200. In some examples, various aspects of the method may be performed in a cloud computing system. The method 200 may begin at block 202.

At block 202, a surface boundary of a 3D object is mapped. In one embodiment, the mapping makes up a surface mesh composed of 2D triangles

At block 204, a volumetric mesh of the 3D object is mapped. The volumetric mesh defines the volume of the 3D object similar to how the surface mesh of 2D triangles defines the outer shell of the 3D object. In one embodiment, the volumetric mesh is a tetrahedral mesh. The tetrahedral mesh may occupy a larger or smaller volume than the surface mesh. In one embodiment, the volume defined outside of the surface mesh is ignored when the 3D object is constructed. In addition, the tetrahedral mesh may be defined at a different resolution than the resolution of the surface mesh. For example, the surface mesh may be defined at a relatively high resolution, in order to show the surface detail typical of manufactured 3D objects. In contrast, the tetrahedral mesh may be defined at a relatively lower resolution to capture material transitions that occur at a lower resolution than the resolution of the detail of the surface mesh. Further, by defining properties in the tetrahedral mesh at a lower resolution than the surface mesh, it is possible to save space in the representation of the 3D object.

At block 206, the properties of an internal volume of the 3D object are mapped into the surface mesh using a volumetric mesh. Using both a volumetric mesh and a surface mesh, allows for the efficient representation of the surface shape and the internal structure. In one embodiment, a larger, coarser volumetric mesh defines the material gradients inside the part, and a fine surface mesh represents intricate detail of the external shape.

At block 208, manufacturing characteristics of internal volumes of the three-dimensional object are mapped as voxels in the volumetric mesh. Similar to pixels being used as textures across a surface, voxels may be used to provide a 3D volumetric texture. For example, a swatch of image (between the U,V coordinates) containing many pixels (or voxels) is stretched onto a triangle of a surface mesh (or tetrahedron of a volumetric mesh). Generally texture mapping is done to put high resolution data onto low resolution meshes. In a volumetric mesh, a 3D voxel may be used to describe the material throughout the volume of the tetrahedron.

At block 210, manufacturing characteristics of internal volumes of the three-dimensional object are mapped as linear gradients in a volumetric mesh. In one embodiment, different materials may be defined at the four vertices of a tetrahedron. Thus, to determine what materials are used throughout the volume of the tetrahedron, the material gradient, a linear gradient of the four different materials may be generated that defines the transitions between the materials. The transitions between materials may be determined similar to the techniques for determining linear color gradients in 2D space.

At block 212, other surface meshes may be mapped into internal volumes of the three-dimensional object. In one embodiment, microstructures may be represented as a surface mesh, mapped into and hollowing out a larger surface mesh, using a volumetric mesh to anchor the mapping. This internal microstructure may be a triangular surface mesh within a larger triangular surface mesh.

At block 214, a model of the 3D object is generated based on the one or more surface meshes, the volumetric mesh, and properties. At block 216, the 3D object may be built based on the model and properties such as, manufacturing characteristics. In one embodiment, the 3D object may be built using the fabricator 100.

This process flow diagram is not intended to indicate that the blocks of the method 200 are to be executed in any particular order, or that all of the blocks are to be included in every case. Further, any number of additional blocks not shown may be included within the method 200, depending on the details of the specific implementation.

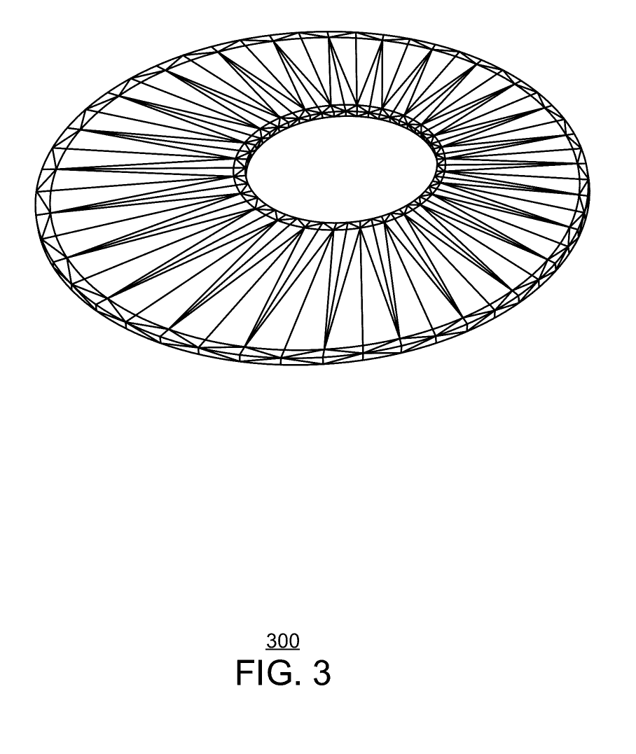

FIG. 3 is a diagram of coincidental triangular and tetrahedral mesh of an example 3D object 300 for manufacture. By using both a volumetric mesh and a surface mesh, the surface shape can be represented at a different level of resolution than the internal structure. This is accomplished by allowing the surface mesh to clip the volumetric mesh, so that a larger, coarser volumetric mesh could define the material gradients inside the part, while the fine surface mesh may describe the intricate detail of the external shape. In such embodiments, a default solid material may be deposited in gaps where no microstructure is defined. In this way, a low resolution of material may fill gaps with a high resolution surface. Additionally, a solid shell can be added around an internal microstructure by generating the internal volumetric mesh smaller than the surface mesh.

In various embodiments, microstructures may be repetitious. In other words, the same surface topologies may be used throughout an object, but each use is slightly warped or stretched. In such embodiments, it is possible to define a microstructure similar to how a texture is defined for texture mapping. However, instead of repeating a texture across a 2D surface, embodiments repeat a 3D volumetric model throughout the volume of a larger object, e.g., object 300.

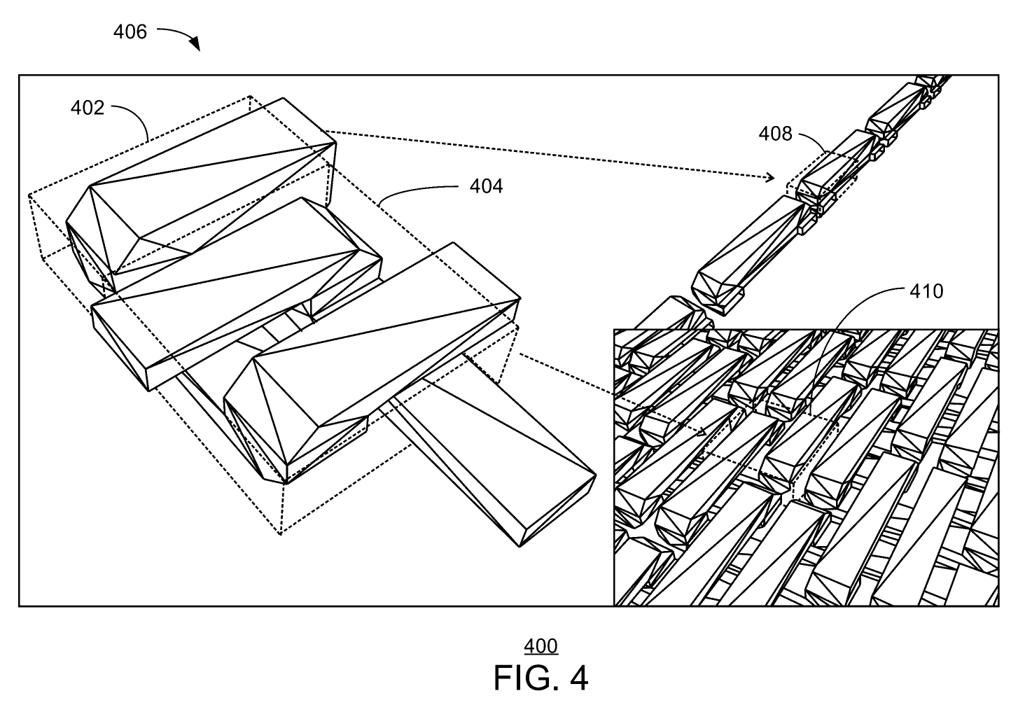

FIG. 4 is a diagram of example surface meshes 402, 404 for a complex 3D object. The surface meshes 402, 404 are mapped into the original shape by using the volumetric mesh 300. The surface meshes 402, 404 each model part of a 3D microstructure 406 that may be mirror tiled across the volume of a volumetric mesh. Each surface mesh 402, 404 represents a portion of an edge link 408, and central link 410, respectively. As shown, each mesh 402, 404 can be tiled repeatedly throughout the volume of the object 300.

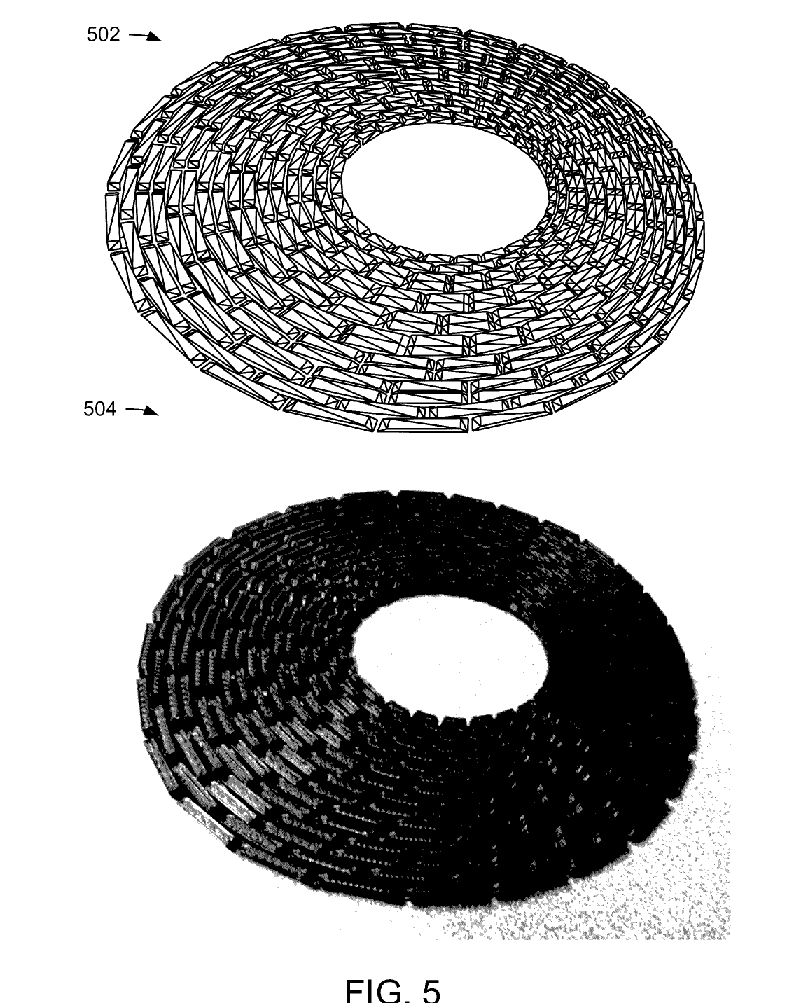

FIG. 5 is a diagram of an example volumetric mesh 502 with mirror tiling and the 3D object 504 manufactured from the volumetric mesh 502. Each individual link of the object 504 is unique in size and shape. A traditional implementation of data representation using ASCII text occupied nearly 5 megabytes of data. In contrast, an implementation using tetrahedral and triangular meshes used only 23 kilobytes of data.

FIG. 6 is intended to provide a brief, general description of a computing environment in which the various techniques described herein may be implemented. For example, a method and system for generating a 3D model to be used for fabricating 3D objects can be implemented in such a computing environment. While the claimed subject matter has been described above in the general context of computer-executable instructions of a computer program that runs on a local computer or remote computer, the claimed subject matter also may be implemented in combination with other program modules. Generally, program modules include routines, programs, components, data structures, or the like that perform particular tasks or implement particular abstract data types.

FIG. 6 is a block diagram of an example operating environment configured for implementing various aspects of the techniques described herein. The example operating environment 600 includes a computer 602. The computer 602 includes a processing unit 604, a system memory 606, and a system bus 608.

The system bus 608 couples system components including, but not limited to, the system memory 606 to the processing unit 604. The processing unit 604 can be any of various available processors. Dual microprocessors and other multiprocessor architectures also can be employed as the processing unit 604.

The system bus 608 can be any of several types of bus structure, including the memory bus or memory controller, a peripheral bus or external bus, and a local bus using any variety of available bus architectures known to those of ordinary skill in the art. The system memory 606 includes computer-readable storage media that includes volatile memory 610 and nonvolatile memory 612.

The basic input/output system (BIOS), containing the basic routines to transfer information between elements within the computer 602, such as during start-up, is stored in nonvolatile memory 612. By way of illustration, and not limitation, nonvolatile memory 612 can include read-only memory (ROM), programmable ROM (PROM), electrically programmable ROM (EPROM), electrically erasable programmable ROM (EEPROM), or flash memory.

Volatile memory 610 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 602 also includes other computer-readable media, such as removable/non-removable, volatile/non-volatile computer storage media. FIG. 6 shows, for example a disk storage 614. Disk storage 614 includes, but is not limited to, devices like a magnetic disk drive, floppy disk drive, tape drive, Jaz drive, Zip drive, LS-210 drive, flash memory card, memory stick, flash drive, and thumb drive.

In addition, disk storage 614 can include storage media separately or in combination with other storage media including, but not limited to, an optical disk drive such as a compact disk, ROM device (CD-ROM), CD recordable drive (CD-R Drive), CD rewritable drive (CD-RW Drive), a digital versatile disk (DVD) drive. To facilitate connection of the disk storage devices 614 to the system bus 608, a removable or non-removable interface is typically used such as interface 616.

It is to be appreciated that FIG. 6 describes software that acts as an intermediary between users and the basic computer resources described in the suitable operating environment 600. Such software includes an operating system 618. The operating system 618, which can be stored on disk storage 614, acts to control and allocate resources of the computer 602.

System applications 620 take advantage of the management of resources by operating system 618 through program modules 622 and program data 624 stored either in system memory 606 or on disk storage 614. It is to be appreciated that the claimed subject matter can be implemented with various operating systems or combinations of operating systems.

A user enters commands or information into the computer 602 through input devices 626. Input devices 626 include, but are not limited to, a pointing device, such as, a mouse, trackball, stylus, and the like, a keyboard, a microphone, a joystick, a satellite dish, a scanner, a TV tuner card, a digital camera, a digital video camera, a web camera, and the like. The input devices 626 connect to the processing unit 604 through the system bus 608 via interface ports 628. Interface ports 628 include, for example, a serial port, a parallel port, a game port, and a universal serial bus (USB).

Output devices 630 use some of the same type of ports as input devices 626. Thus, for example, a USB port may be used to provide input to the computer 602, and to output information from computer 602 to an output device 630.

Output adapter 632 is provided to illustrate that there are some output devices 630 like monitors, speakers, and printers, among other output devices 630, which are accessible via adapters. The output adapters 632 include, by way of illustration and not limitation, video and sound cards that provide a means of connection between the output device 630 and the system bus 608. It can be noted that other devices and systems of devices can provide both input and output capabilities such as remote computers 634.

The computer 602 can be a server hosting various software applications in a networked environment using logical connections to one or more remote computers, such as remote computers 634. The remote computers 634 may be client systems configured with web browsers, PC applications, mobile phone applications, and the like.

The remote computers 634 can be a personal computer, a server, a router, a network PC, a workstation, a microprocessor based appliance, a mobile phone, a peer device or other common network node and the like, and typically includes many or all of the elements described relative to the computer 602. Remote computers 634 can be logically connected to the computer 602 through a network interface 636 and then connected via a communication connection 638, which may be wireless.

Network interface 636 encompasses wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection 638 refers to the hardware/software employed to connect the network interface 636 to the bus 608. While communication connection 638 is shown for illustrative clarity inside computer 602, it can also be external to the computer 602. The hardware/software for connection to the network interface 636 may include, for exemplary purposes, internal and external technologies such as, mobile phone switches, modems including regular telephone grade modems, cable modems and DSL modems, ISDN adapters, and Ethernet cards.

An example processing unit 604 for the server may be a computing cluster. The disk storage 614 may comprise an enterprise data storage system, for example, holding thousands of impressions.

The computer 602 can be configured to generate a 3D model based on a volumetric representation of manufacturing data. The data 624 may include one or more initial 3D models, which may be obtained from a portable storage device or downloaded from a remote computer or via the internet, for example. For example, the 3D model may be a simple model of a trophy or a more complex object, such as a working part of a machine. In some examples, the 3D model includes a 3D tetrahedral model representing the volume of an object for manufacturing. The tetrahedral model may be combined with a 3D surface model, such as a triangle mesh. The triangle mesh clips the tetrahedral mesh. In other words, the triangle mesh is a boundary, beyond which the tetrahedral mesh is ignored.

The data 624 may include one or more 3D images, which may be obtained from a portable storage device or downloaded from a remote computer or via the Internet, for example. The user can select one or more of the 3D images for providing a 3D texture to the volume represented by the tetrahedron.

The user may store the volumetric mesh model to disk storage 614, and send the volumetric mesh model to a fabricator, such as the fabricator 100 described below in relation to FIG. 1. The computations executed by the computer 602 to generate the combined 3D model are described further in relation to FIGS. 2-5.

In some examples, some or all of the processes performed for generating the volumetric mesh can be performed in a cloud service and reloaded on the client computer of the user. For example, some or all of the applications described above for representing the 3D model could be running in a cloud service and receiving input from a user through a client computer. Thus, the calculations involved in computing the volumetric mesh model could be performed on a cloud computing system.

### EXAMPLE 1

This example provides for an example system for representing properties of 3D objects. The example system includes a processor and a computer-readable memory storage device storing executable instructions that can be executed by the processor to cause the processor to map an outer surface of a three-dimensional object as a surface mesh. The example system also includes executable instructions that can be executed by the processor to cause the processor to map properties of an internal volume of the three-dimensional object into the surface mesh using a volumetric mesh. The example system also includes executable instructions that can be executed by the processor to cause the processor to generate a model of the three-dimensional object based on the surface mesh and the properties from the volumetric mesh. The properties may include manufacturing characteristics. The example system also includes executable instructions that can be executed by the processor to cause the processor to build the three-dimensional object. The example system also includes executable instructions that can be executed by the processor to cause the processor to map an additional surface mesh into internal volumes of the three-dimensional object as voxels in the volumetric mesh. Alternatively, or in addition, the properties comprise a composition of material to be used at a specific point represented by a voxel. In addition, the composition of material may be a void of material. Alternatively, or in addition, the surface mesh has two positions for each vertex, and a parameter controls interpolation between the two positions. Alternatively, or in addition, the manufacturing characteristics include a composition of material to be used at a specific point represented by a voxel. Alternatively, or in addition, the composition of material is a void of material.

### EXAMPLE 2

This example provides for an example method for representing properties of 3D objects. The example method includes mapping an outer surface of a three-dimensional object as a surface mesh. The example method includes mapping properties of an internal volume of the three-dimensional object into the surface mesh using a volumetric mesh. The example method also includes generating a model of the three-dimensional object based on the surface mesh and the properties from the volumetric mesh. The example method also includes building the three-dimensional object based on the volumetric mesh and the properties, where the properties comprise manufacturing characteristics. The example method additionally includes mapping a surface boundary of the three-dimensional object as polygons that make up a surface mesh. Alternatively, or in addition to, the polygons comprise triangles, and the surface mesh comprises a triangle mesh. The example method also includes mapping an additional surface mesh into internal volumes of the three-dimensional object as voxels in the volumetric mesh. Alternatively, or in addition to, the properties comprise a composition of material to be used at a specific point represented by a voxel. Alternatively, or in addition to, the composition of material comprises a void of material. Alternatively, or in addition to, the example method includes mapping an internal model of the three-dimensional object as polyhedrons that make up the volumetric mesh.

### EXAMPLE 3

This example provides for an example one or more computer-readable memory storage devices for storing computer readable instructions that, when executed by one or more processing devices, instruct the performance of representing properties of 3D objects. The computer-readable instructions may include code to to map an outer surface of a three-dimensional object as a surface mesh. The computer-readable instructions may include code to map properties of an internal volume of the three-dimensional object into the surface mesh using a volumetric mesh. The computer-readable instructions may include code to generate a model of the three-dimensional object based on the surface mesh and the properties from the volumetric mesh. The computer-readable instructions may include code to build the three-dimensional object based on the surface boundary and the properties, where the properties comprise manufacturing characteristics. The computer-readable instructions may include code to map an additional surface mesh into internal volumes of the three-dimensional object as voxels in the volumetric mesh. Alternatively, or in addition to, the properties comprise a composition of material to be used at a specific point represented by a voxel, and the composition of material comprises a void of material. The computer-readable instructions may include code to map an internal model of the three-dimensional object as polyhedrons that make up the volumetric mesh.

What has been described above includes examples of the disclosed subject matter. It is, of course, not possible to describe every conceivable combination of components or methodologies for purposes of describing the disclosed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component, e.g., a functional equivalent, even though not structurally equivalent to the disclosed structure, which performs the function in the herein illustrated exemplary aspects of the disclosed subject matter. In this regard, it will also be recognized that the innovation includes a system as well as a computer-readable storage media having computer-executable instructions for performing the acts and events of the various methods of the disclosed subject matter.

There are multiple ways of implementing the disclosed subject matter, e.g., an appropriate API, tool kit, driver code, operating system, control, standalone or downloadable software object, etc., which enables applications and services to use the techniques described herein. The disclosed subject matter contemplates the use from the standpoint of an API (or other software object), as well as from a software or hardware object that operates according to the techniques set forth herein. Thus, various implementations of the disclosed subject matter described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the disclosed subject matter may have been disclosed with respect to one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A system for representing properties of three-dimensional objects, the system comprising:
a processor; and
a computer-readable memory storage device storing executable instructions that can be executed by the processor to cause the processor to:
map an outer surface of a three-dimensional object as a surface mesh;
map properties of an internal volume of the three-dimensional object into the surface mesh using a volumetric mesh; and
generate a model of the three-dimensional object based on the surface mesh and the properties from the volumetric mesh.

2. The system of claim 1, wherein the properties comprise manufacturing characteristics, and wherein the processor is to build the three-dimensional object based on the model.

3. The system of claim 1, wherein the surface mesh comprises polygons.

4. The system of claim 3, wherein the polygons comprise triangles, and wherein the surface mesh comprises a triangle mesh.

5. The system of claim 1, wherein the surface mesh has two positions for each vertex, and a parameter controls interpolation between the two positions.

6. The system of claim 1, wherein the properties comprise manufacturing characteristics comprising a composition of material to be used at a specific point represented by a voxel.

7. The system of claim 6, wherein the composition of material comprises a void of material.

8. The system of claim 1, wherein the processor is to map an internal model of the three-dimensional object as polyhedrons that make up the volumetric mesh.

9. The system of claim 1, wherein the processor is to map an additional surface mesh into internal volumes of the three-dimensional object.

10. The system of claim 9, wherein the processor is to map an internal surface mesh that is internal to the additional surface mesh.

11. A method for representing properties of three-dimensional objects, comprising:
mapping an outer surface of a three-dimensional object as a surface mesh;
mapping properties of an internal volume of the three-dimensional object into the surface mesh using a volumetric mesh;
generating a model of the three-dimensional object based on the surface mesh and the properties from the volumetric mesh; and
building the three-dimensional object based on the model.

12. The method of claim 11, wherein the volumetric mesh is mapped as polyhedrons.

13. The method of claim 11, wherein the properties comprise manufacturing characteristics.

14. The method of claim 13, wherein the manufacturing characteristics comprise a composition of material to be used at a specific point represented by a voxel.

15. The method of claim 14, wherein the composition of material comprises a void of material.

16. The method of claim 11, comprising mapping an additional surface mesh into internal volumes of the three-dimensional object.

17. One or more computer-readable memory storage devices for storing computer readable instructions that, when executed by one or more processing devices, instruct the performance of representing manufacturing data, the computer-readable instructions comprising code to:
map an outer surface of a three-dimensional object as a surface mesh;
map properties of an internal volume of the three-dimensional object into the surface mesh using a volumetric mesh;
generate a model of the three-dimensional object based on the surface mesh and the properties from the volumetric mesh; and
build the three-dimensional object based on the model.

18. The computer-readable memory storage devices of claim 17, wherein the properties comprise manufacturing characteristics comprising a composition of material to be used at a specific point represented by a voxel.

19. The computer-readable memory storage devices of claim 18, wherein the composition of material comprises a void of material.

20. The computer-readable memory storage devices of claim 17, the computer-readable instructions comprising code to map an additional surface mesh into internal volumes of the three-dimensional object.
